(19) United States
(12) Patent Application Publication
(10) Pub. No.: US 2012/0279919 A1
(43) Pub. Date: Nov. 8, 2012

(54) MULTISTAGE BIOLOGICAL REACTOR

(76) Inventor: Joseph Atzmon, Ramat Hasharon (IL)

(21) Appl. No.: 13/510,098

(22) PCT Filed: Nov. 16, 2010
(86) PCT No.: PCT/IL10/00949

§ 371 Date: Jul. 24, 2012

Related U.S. Application Data
(60) Provisional application No. 61/261,439, filed on Nov. 16, 2009.

(51) Int. Cl. C02F 3/02

(52) U.S. Cl. 210/610; 210/150

(57) ABSTRACT

A multistage biological reactor mountable within a settling pond is disclosed. The aforesaid system comprises a wastewater inlet, a plurality of individual cells successively conducting a wastewater flow and a treated wastewater outlet. Each cell comprises a hollow framework and a plurality of mesh substrates mechanically fixed to the framework. The substrates are configured for growth of microorganisms thereupon. The substrates in successively disposed cells are characterized by mesh fineness increasing along the wastewater flow from inlet to outlet. The reactor comprises means to dislodge solids built up upon the substrates thereby preventing excess solids buildup upon the mesh, allowing the system to operate in steady state without periodic solids removal.

### FIELD OF THE INVENTION

The present invention relates to a device and method for the treatment of wastewater. In a bioreactor system based on multi-stage design enabled to increase the efficiency of the biochemical endogenous stages resulting in: high quality of purified water, higher flow capacity and high reduction rate of surplus biomass resulting in negligible amount of excess biomass. The invention can be also implemented in modification of preexisting waste water treatment facilities such as activated sludge, aeration ponds, lagoons, etc.

### BACKGROUND OF THE INVENTION

It is known that higher spherical concentration of autotrophic biomass increases the efficiency of biochemical endigenous processes. The results of this process conducted in multi-stage biological reactor under optimal condition provides maximum effective biomass surface concentration in each stage. The optimization of each stage is related to the condition of the treatment in terms of oxygen content, hydraulic design and bio substrate design enabling high levels of organic and inorganic impurities to decompose.

Conventional waste water technology like activated sludge processes operated in waste water plant or aerated lagoons, produced large amount of excess biomass due to process conditions which encourage mass reproduction, resulting in the need for high attention and energy to control the biomass during the process.

It is known that by using fixed submerged biomass the process can be more effective, but under high load this system can be plugged by the excess of sludge built up. Floating biomass carriers increased the active surface but the treatment cannot reduce the amount of excess sludge to low or very low level.

The present rotational bioreactors design is based on a construction adapted to carry the load on a axis, which results in a mechanical problem namely that the system provides oxygen to the biomass on the disk surface while emerging from the water but not directly to the water, resulting in low oxygen content under hot weather conditions which therfore produce bad odors.

U.S. Pat. No. 7,794,599 discloses a bioreactor system for multistage biological wastewater treatment. The aforesaid bioreactor system includes at least one flexible substrate for supporting biomass growth having a plurality of threads and at least two cross support elements wherein openings defined by adjacent threads and adjacent cross support openings have an aspect ratio exceeding 50:1.

U.S. Pat. No. 6,136,194 discloses a method and a device for treating wastewater. A wastewater treatment system substantially reduces wastewater treatment time and increases treatment capacity. The system includes at least one completely covered aerobic reactor cell and a completely covered quiescent anaerobic reactor cell. The system can also include a polishing reactor for further treating wastewater after treatment by the anaerobic reactor cell. The covered aerobic reactor cell preferably includes a pair of subcells in which a first cell includes continuous mixing and aeration of the wastewater and the second cell includes only intermittent mixing and aeration of the treated wastewater. The system optionally includes a completely covered anoxic reactor cell for treating wastewater prior to treatment by the completely covered aerobic reactor cell. The anoxic reactor cell receives partially treated wastewater recirculated from the polishing reactor. Growth media can be used in the reactor cells to enhance biological activity. The system can be used to retrofit a preexisting wastewater treatment facility.

Hence a method for modification of aerated ponds to provide a short process time and a space saving non sludge pond solution is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 is a general schematic top view of the multistage biological reactor;

FIGS. 2a to 2d are schematic cross-sectional views of the alternative embodiments of the cage cells provided with the substrates carrying biomass;

FIGS. 3a to 3c are schematic views of biomass substrates;

FIG. 4 is a schematic cross-sectional view of the line of the cages provided with the substrates carrying biomass;

FIG. 5 is a schematic cross-sectional view of the multistage biological reactor provided with the biodiscs;

FIG. 6 is a schematic cross-sectional view of the air-driven biodisc; and

FIG. 7 is a schematic cross-sectional view of the wastewater-flow-driven biodisc.

### SUMMARY OF THE INVENTION

The invention relates to a multi stage biological system, useful in municipal and industrial wastewater treatment systems. It is intended for waste streams without excess of organic sludge. The device is based on an array of modular units that can be easily arranged into a variety of configurations to take advantage of existing infrastructure such as settling ponds. The individual units are comprised of cells made of a membranous material such as polyethylene, HDPE, The cell material is suitable for growth of a variety of microorganisms, as determined by the specific situation. The cells are adapted to treat the wastewater due to the presence and growth of microorganisms that break down various wastes in the water as part of their metabolic activity. The design is capable of dealing with high waste loadings of chemical organic and biological waste, and to different hydraulic loads.

It is hence one object of the invention to disclose a multistage biological reactor mountable within a settling pond. The aforesaid system comprises (a) a wastewater inlet; (b) a plurality of individual cells successive disposed along a wastewater flow; each cell comprising (i) a hollow framework; and (ii) a plurality of mesh substrates mechanically fixed to the framework, the substrates being configured for growth of microorganisms thereupon; (c) a treated wastewater outlet.

It is a core purpose of the invention to provide the substrates in the successive cells characterized by mesh fineness increasing along the wastewater flow from inlet to outlet. The reactor further comprises means to dislodge solids built up upon the substrates thereby preventing excess solids buildup upon the mesh, allowing the system to operate in steady state condition.

Another object of the invention is to disclose a distance between the substrates in the successively disposed cells. The aforementioned distance increases along the wastewater flow from inlet to outlet.

A further object of the invention is to disclose the dislodging means comprising a plurality of free-floating elements.

A further object of the invention is to disclose the dislodging means comprising means adapted for stirring the substrates selected from the group consisting of vibrating means, brushing means, shearing means, bending means, aerating means, agitating means and any combination thereof.

A further object of the invention is to disclose at least one individual cell configured into a drum-like symmetrical form.

A further object of the invention is to disclose the drum-like cell adapted to be waterlogged on a surface of the wastewater;

A further object of the invention is to disclose the drum-like cell driven by air flow fed by a pipe disposed under the drum-like cell asymmetrically to an axis thereof.

A further object of the invention is to disclose the drum-like cell driven by wastewater flow.

A further object of the invention is to disclose at least one cell configured into a watertight cage.

A further object of the invention is to disclose a plurality of the cages arranged into at least two-row arrangement; the rows are divided by at least one flow separator board.

A further object of the invention is to disclose each cages separated from the group consisting of a cage disposed on a bed of the settling pond, a floating cage, a cage supported by a supporting frame and a cage mechanically fixed to the separator board.

A further object of the invention is to disclose an opening gap size of the substrates being constant or increasing along the wastewater flow from inlet to outlet.

A further object of the invention is to disclose the ratio of mass to surface area of the system being equal to or greater than about 0.1 kg/m².

A further object of the invention is to disclose the ratio of surface area to volume of the system being equal to or greater than about 8 m²/m³.

A further object of the invention is to disclose the substrates provided with the opening gap size of between about 1 mm and about 40 mm.

A further object of the invention is to disclose the substrate composed of material selected from the group consisting of thermoplastic resins and reinforced compounds material like: HDPE, LDPE, polyamide, polypropylene, polybutylene, polyester, PET, thermosetting materials like: glass epoxy, fiberglass, polyurethane, compressed carbon & activated carbon with epoxy resins.

A further object of the invention is to disclose the free-floating elements taking a form selected from the group consisting of: hollow spheres, polygons, irregular solids, porous shapes, extruded shapes, pellets of reground material, and pellets of shredded plastic.

A further object of the invention is to disclose the free-floating elements characterized by a size between about 5 and about 30 mm

A further object of the invention is to disclose the free-floating elements composed of material selected from the group consisting of metal, plastic, composite material, ceramics, thermoplastic, inorganic carbon based material, foam concrete and combinations thereof.

A further object of the invention is to disclose material characterized by material density between 0.8 to 1.2 kg/cm3

A further object of the invention is to disclose the frameworks being collapsible allowing for easy transport and storage.

A further object of the invention is to disclose the drum-like cell driven by a floating unit mechanically connected to the drum-like cell. The floating unit comprises a motor and transmission operated by air, electric or hydraulic sources.

A further object of the invention is to disclose a depth of immersion of the floating drum-like cell is adjustable according to the desired oxidation rate.

A further object of the invention is to disclose a method for biological wastewater treatment comprising the steps of (a) providing a multistage biological reactor further comprising (i) a wastewater inlet; (ii) a plurality of individual cells successive disposed along a wastewater flow; each cell comprising: (1) a hollow framework; (2) a plurality of mesh substrates mechanically fixed to the framework, the substrates being configured for growth of microorganisms thereupon, (iii) a treated wastewater outlet; (b) mounting the reactor within a settling pond; (c) introducing wastewater into the multistage biological reactor; (d) forcing the wastewater to flow through the plurality of cells; (e) biologically treating the wastewater by contacting biomass carried by the substrates with the wastewater; and (f) discharging the treated wastewater.

It is a core purpose of the invention to provide the step of biologically treating which is performed by the biomass carried by substrates characterized by increasing the density of the substrates and mesh porosity along the wastewater flow from inlet to outlet. The method further comprises a step of constant and stable dislodging solids built up upon the substrates.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a wastewater treatment system.

In the following detailed description, numerous specific details are set forth in order to provide a thorough understanding of embodiments of the present invention.

However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘multi-stage biological reactor (MSBR)’ refers to the system of the current invention where gradually finer mesh fabric are used to provide highly active substrate surface wastewater, wherein the organic particles and molecules are simultaneously broken down by microorganisms.

The term ‘mesh fineness’ refers to the spacing between adjacent gaps of a mesh; a mesh with higher fineness with have more holes per square cm.

The term ‘plurality’ refers hereinafter to any positive integer e.g, 1, 5, or 10.

The term “opening gap size” refers hereinafter to an distance between closest fibers of a net.

The term “cell”—refers to a chamber of treated volume containing at least one cage.

The present invention comprises an attached culture system and method for wastewater treatment consisting of a set of flexible and collapsible mesh mounted on “cages” that can be deployed in settling ponds. The cages are provided with a series of screens of a certain mesh size, through which waste water flows and upon which biological material can flourish. The aforesaid can be shaped, in an unlimited manner, into a parallelepiped-like or cylindrical form The cages require a minimum of material for their construction, ensuring low weight, low cost, and the collapsible nature of the cages ensures convenient transportation. They may be stacked in layers for use in deep ponds and may be provided with floats to float on the pond surface. The cages may be further used in other sites differing from settling ponds, such as dedicated treatment units. The mesh fineness of the screens in successive cages will increase downstream of the liquid flow. The proposed technical solution teaches placing the coarser screens nearby the wastewater inlet characterized by maximal organic load and finer screens near the outlet with minimal organic load.

Within these cages a variety of microorganisms flourish. Thus the invention actually constitutes a multi stage biological system, useful in municipal and industrial wastewater treatment systems. The system is intended for waste streams without excess of organic sludge. The device is based on an array of modular units that can be easily arranged into a variety of configurations to take advantage of existing infrastructure such as settling ponds. The individual units are comprised of cells made of a substrate material such as polyethylene. Commercially available sunshade high density polyethylene (HDPE) net is suitable to substrate production because of: its high tensile strength, durability and corrosion and UV radiation resistance. The cell material is suitable for growth of a variety of microorganisms, as determined by the specific situation. The cells are adapted to treat the wastewater due to the presence and growth of microorganisms that break down various wastes in the water as part of their metabolic activity. The design is capable of dealing with high waste loadings of chemical organic and biological waste, and to different hydraulic loads. The device is designed with successively finer mesh sizes as the waste stream passes through the system. Thus the loading on the modular elements of the system will be balanced, so increasing the efficiency by providing more contact area to treated volume, unlike the case in previous systems where the bio substrate is a constant structure.

Biological treatment of the wastewater is performed by a sequence of cells. The quantity of biomass accommodated in each cell decreases along a flow of the processed wastewater. In other words, the quantity of the biomass at specific cell is smaller than the biomass quantity at the previous cell. Decrease in biomass quantity from cell to cell is accompanied by a self consuming process caused by biomass starvation due to reduction of food quantity (organic material). The aforesaid wastewater treatment process is characterized at the end of the process by nonoccurrence of sludge deposits. All the cells work under mixing condition preventing sedimentation. With the absence of clarifier and sludge accumulation condition there is no need for removal of sludge depositions or sludge treatment and their transportation to a storage location.

A critical aspect of the system is that it operates in a steady-state, without requirement for periodic cleaning of the bio substrates or removal of sludge buildup. Thus any solids buildup will occur over the enormous area of the substrates, which may reach upwards of 100 m² for every cubic meter of device used. In addition, free-floating elements are added to the device, contained within the cages, which tend to knock loose any excess sludge buildup and thus prevent clogging of the system. The organic matter incoming into the system is thus mostly or (in the steady state) entirely released as CO₂ gas above the device by the photosynthetic action of the biological elements of the system, and a steady state can be maintained wherein the outgoing levels of organic matter (BOD, COD, TSS) are far lower than the incoming levels. The free floating elements mentioned may comprise, for instance, plastic hollowed spheres of radius ˜7-15 mm or the like. The main requirement is that they are small enough to be effective in knocking loose built-up solids, large enough to not pass through the mesh of the devices, and through the net at the end of the cell and resistant to corrosion.

The cages can be adapted to most geometric shapes required, and allow for storage and transport in a collapsed form. The cages may be square, round in horizontal or vertical cross section. The devices may be composed of concrete, steel, plastics, composites, or combinations thereof.

The devices may be located on the ground, underground, floating in water under treatment, supported by rods within the liquid under treatment, or separated by supports of plastic or other material.

It is within provision of the invention that turbulizers be used to increase the turbulence within the waste stream.

It is within provision of the invention that pumps be used to pump air and/or other gases into the waste stream.

The device of the present invention allows for treatment without need for active water pumping. It will be appreciated however that some form of control over the flow rate into and out of e.g. a settling pond filled with the cages of the present invention is advisable.

The individual units may be comprised of mesh selected for the particular conditions relevant, with the goal of preventing growth that will clog the cells, on the one hand, and a desire to provide the maximum surface area for biological treatment For purposes of increasing the surface area of the device and in order to eliminate the need for supports for the fabric, part of the device volume is itself composed of woven fabric allowing supports having rhomboid or quadrilateral 3D cross section. Thus the device can be collapsed for transport or storage. The 3D shape enables support of the fabric by tension and saves the frame structure of 2D conventional cage.

It is within provision of the device that it be used in a trickling system that works by dripping a waste stream under the force of gravity.

It is within provision of the invention that the device be used for evaporation, and for cooling towers.

It is within provision of the invention that a ratio of active surface area to device weight of about 0.15 kg/m² or greater be attained by the device.

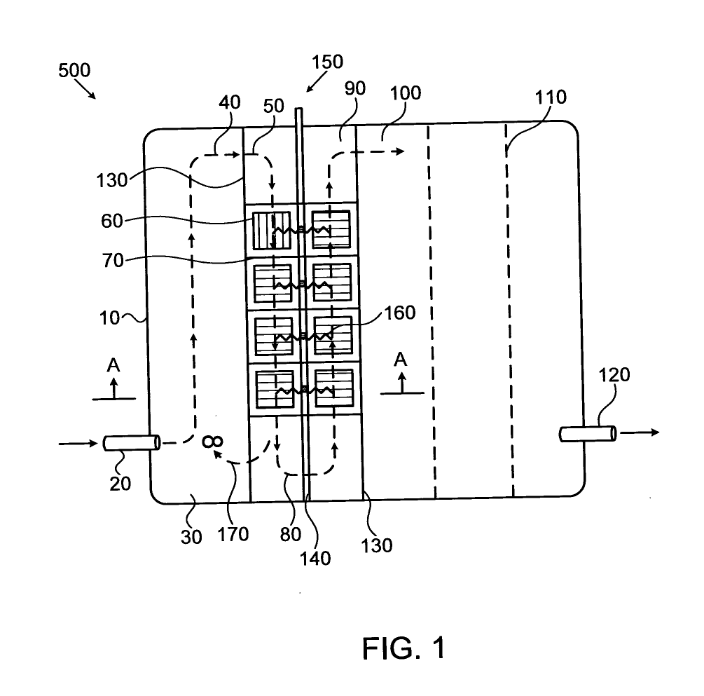

Reference is now made to FIG. 1, presenting an exemplary multistage biological reactor 500 mountable into a settling pond or another watertight basin (not shown). The interior space of the reactor 500 is defined by a watertight housing 10. Wastewater enters the reactor 500 through an inlet pipe 20. The wastewater at first is treated in an anoxic zone 30. Then, the wastewater is treated in a front cell of agitation 50, a plurality of individual cells 60 of biological treatment including substrates carrying biomass (not shown), transitional cells 80 and an exit cell 90. The cells 50, 60, 80 and 90 are separated from other space by means of divider 130 having inlet and outlet openings 50 and 100, respectively. The cells 50, 60, 80 and 90 are separated from each other by means of transverse dividers 70. The wastewater to be treated is pumped through the cells 50, 60, 80 and 90. The treated waste water enters a zone coated with a cover material 110 preventing the treated waste water from algae growth, evaporation and thermal changes. (The cover material contains foam and fabric to operate as biological odor removal integrated system, and maintenance floating surface) Then, the treated waste water is dispensed from the outlet pipe 120. Compressed air is fed into inlet pipe 150 and through a manifold 140 and a system of pipes 160 disposed in the cells 60. Numeral 170 refers to an agitator optionally adapted for recirculation from the cell 80 to the cell 30.

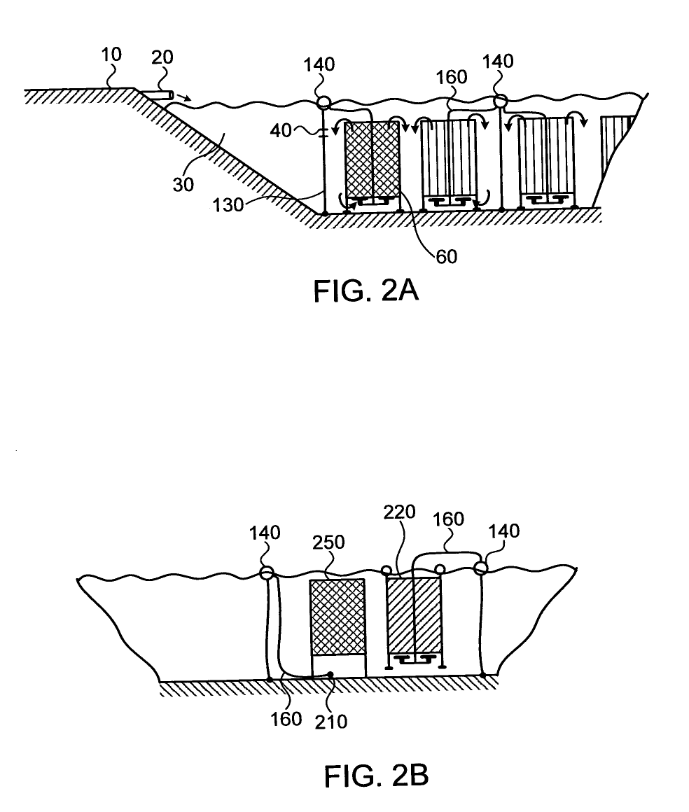

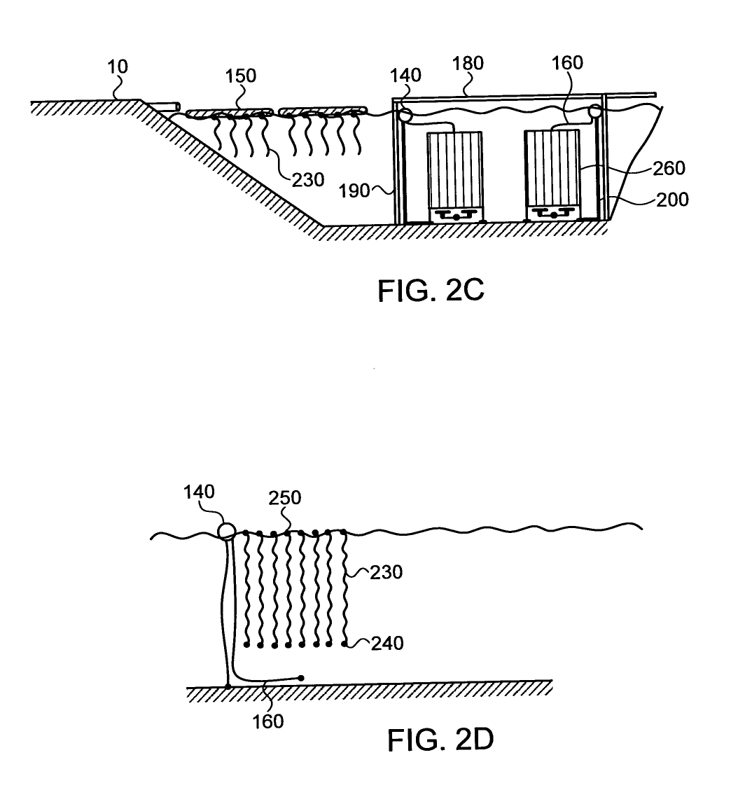

Reference is now made to FIGS. 2a to 2d presenting cells of biological treatment placed between dividers 130 (2a), internal and external cage aeration (2b), cells placed within a housing (2c) and cells suspended on supporting or floating posts or elements (2d).

Specifically, as seen in FIG. 2a, the wastewater is fed into the anoxic zone 30 and then through the opening 40 in the divider 130 enters the cells of the biological treatment 60 placed between dividers 130. Air manifold 140 is fixed to the divider 130.

FIG. 2b presents a cell of biomass 250 placed on a pond bed provided with an external aerator 210 and a cell of biomass 220 provided with and internal aerator. In FIG. 2c, 150 is a floating covering containing a biological odor removal system, 190 is a supporting post, 200 is an isolating plastic divider, 230 is substrate suspended with a stabilizing structure. In FIG. 2d, 240 is a stabilizing weight.

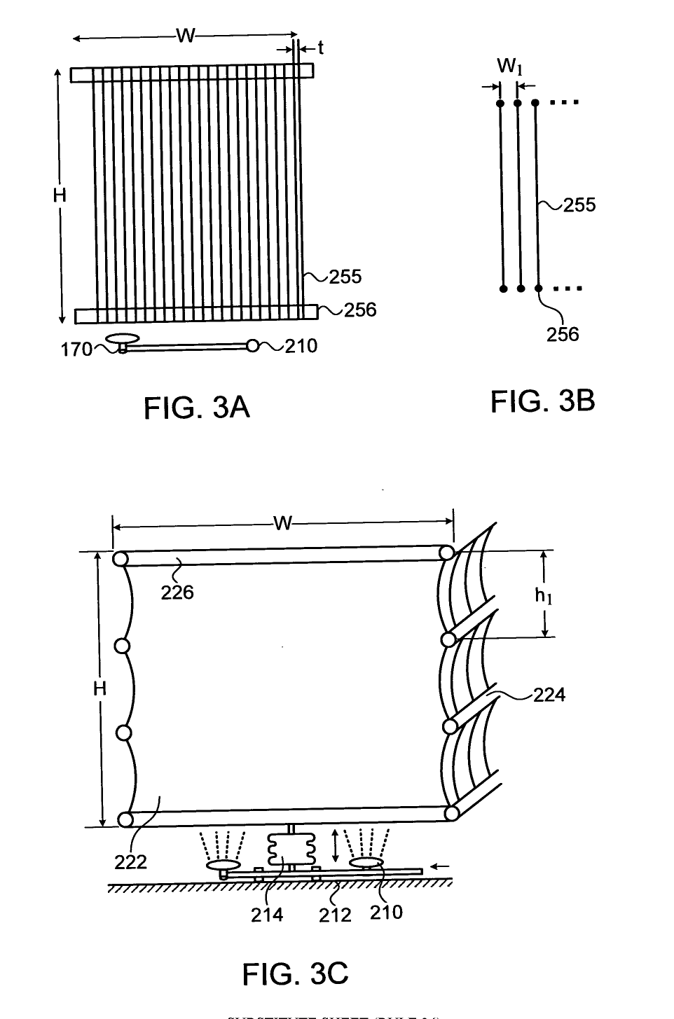

Reference is now made FIGS. 3a to 3c, presenting alternative embodiments of the biomass cells. Specifically, in FIG. 3a, in an unlimited manner, wires 255 of length H configured for carrying biomass layer are strained between bars 256. Numerals 170 and 210 refer to mechanical turbulizer and aerator, respectively. FIG. 3b shows side view onto rows of wire. Referring to FIGS. 3a and 3b, distances t and W₁ between the wires increases along to the wastewater flow. FIG. 3c shows substrates 222 of linear dimensions W and H are strained between bars 226. Substrate tension is assisted by rods 224 mechanically connected on the side the substrates 222. Dislodging means are unlimitedly presented by aerators 210 and a mechanical drive 214 disposed on the bed 212 of the pond or another stationary object. The drive 214 is adapted for reciprocative motion of the low bar 226 resulting in tension and loosening of the substrates 222.

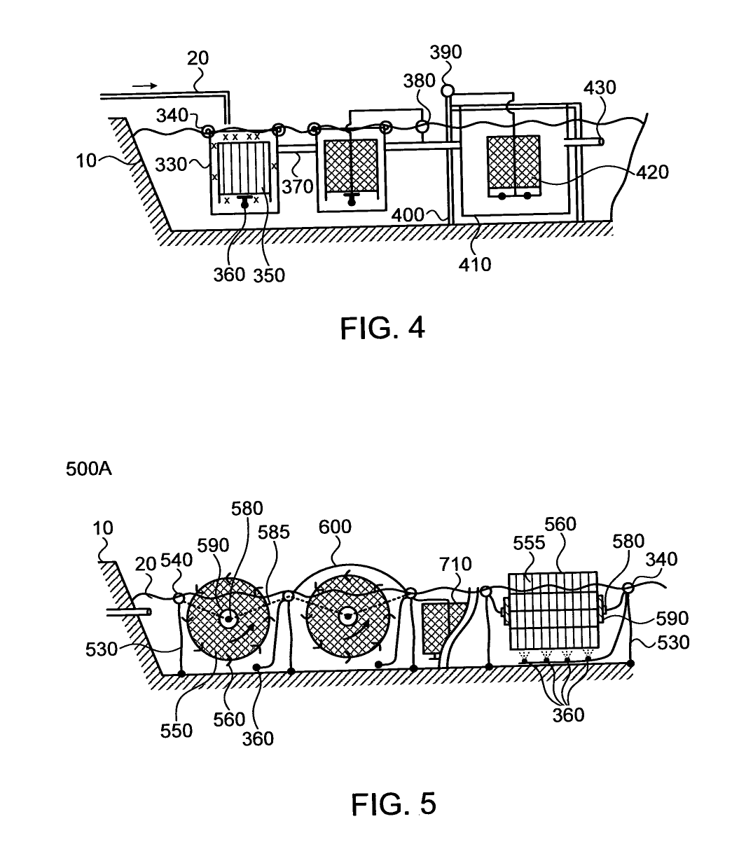

Reference is now made to FIG. 4, showing different embodiments of biomass cell. A biomass cell 350 floats being suspended on floats 340. An alternative embodiment constitutes a biomass cell 420 suspended on a resistive supporting structure made of fiber reinforced polymer 400. Compressed air is fed into floating and stationary pipe systems 380 and 390, respectively. The biomass cell 420 is accommodated within a sealed canister 410. The compressed air is dispensed by dispensers 360.

Reference is now made to FIG. 5, showing a multistage biological reactor 500a provided with biodiscs 550 which are configured to be rotatable around an axis 580. The biodisc comprises a plurality of substrates adapted for carrying biomass layer (not shown). The axis 580 is optionally fixed by a mechanical link 585. Biodisc cells are comparted by flexible or rigid dividers 530. The biodisc is driven by an air flow dispensed by the dispenser 360. The dispensed air is expulsed from wastewater and drives the biodisc 550 due to exertion on v-shaped baffles 560 to improve hydrodynamic properties. In accordance with another embodiment of the current invention, the biodisc cell is provided with a cover 600. Numeral 710 refers to a sealed cell made of plastic panels.

The biomass cage cell 555 comprises a plurality of biomass carrying substrates (not shown. The biomass cage cell 555 is suspended on the air supply pipe 340. The biomass cage cell 555 is balanced by at least two floats 590 and hollowed structure parts.

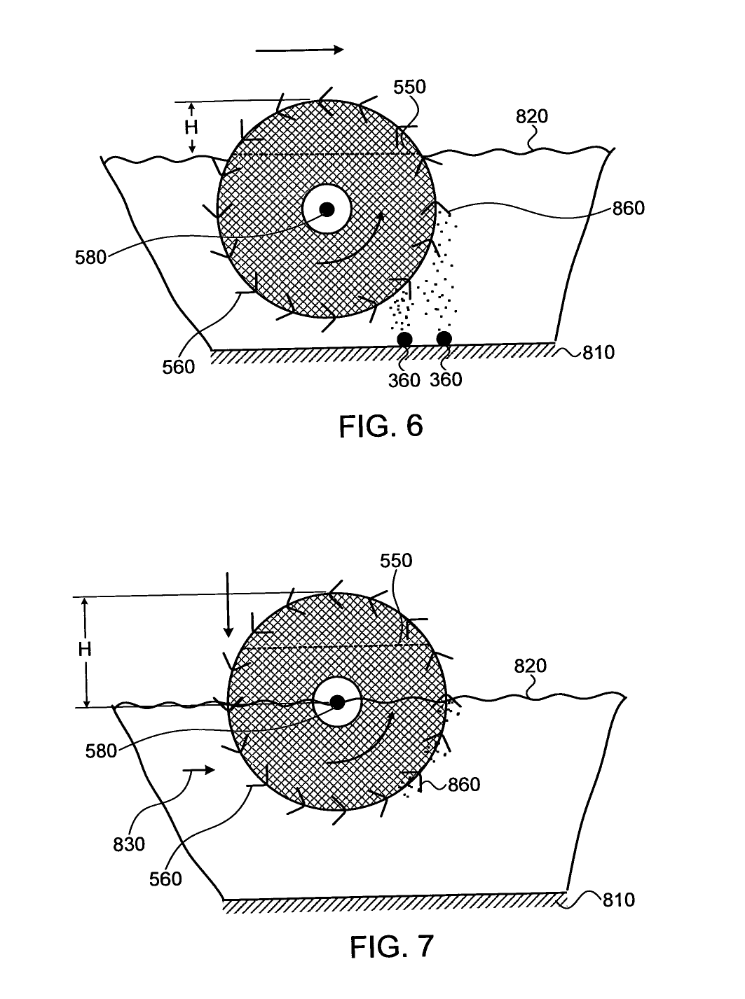

Reference is now made to FIG. 6, showing an enlarged view of the biodisc 550. The aforesaid biodisc 550 rises above a wastewater level 820 up to a height H. The aforesaid biodisc 550 is driven due to application of a rotating moment to the baffles 560 produced by the air lift effect 860.

It is important to note that this type of biodisc is not fixed a rigid mechanical axis, or fulcrum, but is specifically adapted to rotate freely under influence of airlift, and achieves a predetermined balance and buoyancy. The level above water can be automatically or manually adjusted by controlling the volume of the float 590.

Reference is now made to FIG. 7, presenting an alternative embodiment of the biodisc 555 driven by the wastewater flow. It should be emphasized that the axis 580 is mechanically fixed or suspended by the wire 585 (FIG. 5), The biodisc rotates without additional energy consumption.

1-45. (canceled)

46. A multistage biological reactor system mountable within a settling pond, said system comprising:
a) a wastewater inlet;
b) a plurality of individual cells successively conducting a wastewater flow; each cell comprising:
i) a hollow framework;
ii) a plurality of substrates mechanically fixed to said framework, said substrates being configured for growth of microorganisms thereupon,
c) a treated wastewater outlet;
wherein said substrates in said successively disposed cells are characterized by increasing substrate fineness along said wastewater flow from inlet to outlet; wherein said system further comprises means to dislodge solids build up upon said substrates thereby preventing excess solids buildup upon said substrates, allowing said system to operate in steady state of solid removal.

47. The system according to claim 46, wherein a distance between said substrates in said successively disposed cells increases along said wastewater flow from inlet to outlet.

48. The system according to claim 46, wherein said dislodging means comprises a plurality of free-floating elements.

49. The system according to claim 46, wherein at least one individual cell is configured into a drum-like symmetrical form.

50. The system according to claim 49, wherein said drum-like cell is adapted to be waterlogged on a surface of said wastewater.

51. The system according to claim 50, wherein said drum-like cell is driven by air flow fed by a pipe disposed under said drum-like cell asymmetrically to an axis thereof.

52. The system according to claim 50, wherein said drum-like cell is driven by wastewater flow.

53. The system according to claim 50, wherein said drum-like cell is driven by a floating unit mechanically connected to said drum-like cell; said floating unit comprises a motor and transmission operated by air, electric or hydraulic source.

54. The system according to claim 50 wherein a depth of immersion of said floating drum-like cell is adjustable according to desired oxidation rate.

55. The system according to claim 46, wherein at least one cell is configured into a watertight cage.

56. The system according to claim 50, wherein a plurality of said cages is arranged into at least two-row arrangement; said rows are divided by at least one flow separator board.

57. The system according to claim 50, wherein each cages is separated from the group consisting of a cage disposed on a bed of said settling pond, a floating cage, a cage supported by a supporting frame and a cage mechanically fixed to said separator board.

58. The system of claim 46, wherein an opening gap size of said substrates constant or increases along said wastewater flow from inlet to outlet.

59. The system of claim 46, wherein the ratio of surface area to mass of said system is equal to or greater than about 0.1 kg/m².

60. The system of claim 46, wherein the ratio of surface area to volume of said system is equal to or greater than about 8 m²/m³.

61. The system of claim 46, wherein said substrates are provided with said opening gap size of between about 1 mm and about 40 mm.

62. The system of claim 46, wherein said substrate is composed of material selected from the group consisting of thermoplastic resins and reinforced compounds material like: HDPE, LDPE, polyamide, polypropylene, polybutylene, polyester, PET, thermosetting materials like: glass epoxy, fiberglass, polyurethane, compressed carbon & activated carbon with epoxy resins.

63. The system of claim 48, wherein said free-floating elements take a form selected from the group consisting of: spheres, polygons, irregular solids, porous shapes, extruded shapes, pellets of reground material, and pellets of shred plastic; said free-floating elements is characterized by a size between about 5 and about 30 mm.

64. The system of claim 48, wherein said free-floating elements are composed of material selected from the group consisting of metal, plastic, composite material, ceramics, thermoplastic, inorganic carbon based material, foam concrete and combinations thereof; said material characterized by material is density between 0.8 to 1.2 kg/cm³.

65. A method for biological wastewater treatment comprising the steps of:
a. providing a multistage biological reactor further comprising
i. a wastewater inlet;
ii. a plurality of individual cells successive disposed along a wastewater flow; each cell comprising:
1. a hollow framework; and
2. a plurality of mesh substrates mechanically fixed to said framework, said substrates being configured for growth of microorganisms thereupon, and
iii. a treated wastewater outlet;
b. mounting said reactor within a settling pond;
c. introducing waste water into said multistage biological reactor;
d. forcing said wastewater to flow through said plurality of cells
e. biologically treating said wastewater by contacting biomass carried by said substrates with said wastewater; and
f. discharging the treated wastewater
wherein said step of biologically treating is performed by said biomass carried by substrates characterized by a mesh fineness increasing along said wastewater flow from inlet to outlet; said method further comprises a step of dislodging solids built up upon said substrates without periodic solids removal.
